(19) United States
(12) Patent Application Publication
(10) Pub. No.: US 2025/0341128 A1
(43) Pub. Date: Nov. 6, 2025

(54) ARRANGEMENT COMPRISING AT LEAST ONE FOLDING DOOR OR FOLDING-SLIDING DOOR

(71) Applicant: Julius Blum GmbH, Hoechst (AT)

(72) Inventor: Lukas BLUM, Hoechst (AT)

(21) Appl. No.: 19/271,236

(22) Filed: Jul. 16, 2025

Related U.S. Application Data
(63) Continuation of application No. PCT/AT2023/060452, filed on Dec. 22, 2023.

(30) Foreign Application Priority Data
Jan. 19, 2023 (AT) A 50024/2023

(51) Int. Cl. E06B 3/48; E05C 17/08; E05F 1/08

(52) U.S. Cl. CPC E06B 3/482; E05C 17/085; E05F 1/08; E05Y 2201/48; E05Y 2201/628; E05Y 2201/638; E05Y 2900/20

(57) ABSTRACT

An arrangement includes a folding door or folding-sliding door, which comprises at least two door leaves connected to one another in an articulated manner. An ejector device is arranged on a first of the two door leaves for at least partially transferring the folding door or folding-sliding door from a folded open position into a closed position. The at least two door leaves are arranged in a common closing plane, and a holding element is arranged on the second of the two door leaves. The ejector device has an ejector element which can be brought into engagement with the holding element in the open position to hold the folding door or folding-sliding door in the open position. The ejector element is configured to apply a force to the holding element to move the second door leaf from the open position into the closed position.

The present application is a continuation of International Application PCT/AT2023/060452 filed on Dec. 22, 2023. Thus, all of the subject matter of International Application PCT/AT2023/060452 is incorporated herein by reference.

### BACKGROUND OF THE INVENTION

The invention relates to an arrangement with at least one folding door or folding-sliding door, which comprises at least two door leaves connected to each other in an articulated manner. At least one ejector device is arranged on a first of the two door leaves for transferring the at least one folding door or folding-sliding door from a folded open position, at least partially, into a closed position. The at least two door leaves are arranged in a common closing plane, at least one holding element is arranged on the second of the two door leaves, and the ejector device has at least one ejector element. The invention also relates to a piece of furniture with a fixed furniture part and at least one such arrangement.

Arrangements for moving a folding door or folding-sliding door from an open position to a closed position are already known from the prior art. A disadvantage of these arrangements is that the folding door or folding-sliding door can also be moved unintentionally toward a closed position by accidental contact with a user.

The objective of the present invention is to provide an improved arrangement compared to the prior art, as well as a piece of furniture comprising at least one such arrangement.

### SUMMARY OF THE INVENTION

According to the invention, at least one ejector element can be brought into engagement with the holding element in the open position in order to hold the at least one folding door or folding-sliding door in the open position, and the at least one ejector element is designed to apply a force to the holding element in order to move the second door leaf from the open position to the closed position.

This means that the folding door or folding-sliding door is held in an open position by the ejector device and the holding element, thus preventing it from moving unintentionally. If the folding door or folding-sliding door is to be closed, a force can be applied to the holding element via the ejector device, thereby supporting the closing process.

The ejector element has a dual function. On the one hand, the folding door or folding-sliding door can be held in the open position via the ejector element. On the other hand, the folding door or folding-sliding door can be moved toward the closed position via the ejector element.

With regard to a piece of furniture with such an arrangement, it is provided that the at least one folding door or folding-sliding door is mounted on the at least one fixed furniture part.

The at least one ejector element may have an engagement opening, wherein a locking bolt of the holding element can be brought into engagement with the engagement opening. This is a simple way of creating an interface between the holding element and the ejector element.

It may be preferable for the at least one ejector device to have at least one locking device for releasably locking the holding element to the at least one ejector element. A locking device ensures that the connection between the holding element and the ejector element cannot be accidentally released.

It may be preferred that the at least one locking device can be unlocked when the ejector device is mounted by applying pressure to the folding door or folding-sliding door, preferably in the area in which the holding element is arranged. This represents a simple and intuitive solution to the locking device.

It may be particularly preferred that the folding door or folding-sliding door is compressed beyond an open position when unlocked by the application of pressure. This also increases safety against unintentional release of the locking device.

According to a further embodiment, the locking device may comprise at least one control cam, preferably a heart-shaped control cam. At least one control pin is arranged or formed on the at least one ejector element and is guided in the control cam. The control cam and control pin allow the ejector element to be guided in a simple manner so that it can both engage with the holding element and apply a force to the holding element.

It may be preferred that the ejector element can be actuated by at least one force storage member that can be loaded manually by a user, and preferably the force storage member comprises at least one leaf spring. A user can therefore charge a force storage member when opening the folding door or folding-sliding door. When closing the folding door or folding-sliding door, a force stored in the force storage member can then be used to apply a force to the holding element and thus support the closing process of the folding door or folding-sliding door.

According to a further embodiment, the at least one ejector element can be locked by the locking device against the action of the at least one charged force storage member. This is a simple way of keeping a force stored in the force storage member available until said force is used.

It may be preferred that the ejector device comprises at least one, preferably two, bearing elements.

It may be particularly preferred that the at least one ejector element is pivotably mounted on the at least one bearing element.

Furthermore, the bearing element can have at least one fastening section for fastening the at least one bearing element to a door leaf.

A bearing element is a simple design option for mounting an ejector element so that it can pivot on a door leaf.

According to an embodiment, the control cam is formed on the at least one bearing element. This means that a control cam can be implemented in a space-saving manner and with low manufacturing costs.

Advantageously, the ejector device may comprise at least one limiting device for limiting a rotational movement of the at least one ejector element. Such a limiting device ensures that the ejector element can only be moved within a permissible range, thereby also preventing the folding door or folding-sliding door from being moved unintentionally from an open position to a closed position.

The limiting device can comprise at least one limiting curve, wherein a limiting bolt arranged or formed on the at least one ejector element is guided in the limiting curve. This is a simple way to implement a limiting device.

If the limiting curve is formed on at least one bearing element, the limiting device can be implemented in a space-saving manner.

It may be preferred that the at least one force storage member acts between the at least one bearing element and the at least one ejector element. The at least one force storage member can thus be integrated into the ejector device in a space-saving manner.

Advantageously, at least two ejector elements can be provided, wherein the at least two ejector elements are pivotably mounted on a common axis. This increases the stability and reliability of an ejector device.

It may be preferred that the at least one ejector element comprises a swivel element and an engagement element.

It may be particularly preferred that the control pin and/or the limiting pin are arranged or formed on the swivel element, and/or that the swivel element has a receptacle for at least partially accommodating the force storage member.

The engagement element can have the engagement opening.

The retaining element thus engages with one part (engagement element) of the ejector element. However, a force is applied to the retaining element via another part (swivel element) of the ejector element. This structural separation allows each part to be better adapted to its respective function.

Furthermore, the ejector device can have at least one overload protection device. An overload protection device can be used, for example, to ensure that a user does not damage an ejector device when attempting to close the folding door or folding sliding door incorrectly.

According to an embodiment, the swiveling element and the engagement element can be part of the overload protection device, and the engagement element can have a control contour which can be acted upon by a second force storage member.

It is also possible that, when a predetermined force is reached, the engagement element can be pivoted relative to the swivel element against the force exerted by the second force storage member. This is a simple way of providing overload protection.

It may be preferable for the second force storage member to be mounted on or in the swivel element. This reduces the space required for the overload protection device.

### BRIEF DESCRIPTION OF THE DRAWINGS

Further details and advantages of the invention will be explained in more detail below with reference to the drawings, in which:

FIG. 1a is a perspective, schematic view of a piece of furniture in a closed position,

FIG. 1b is a perspective, schematic view of a piece of furniture in an open position,

FIG. 2a-c are schematic top views of an opening process of a piece of furniture,

FIG. 3a is a perspective, schematic view of an ejector device and a retaining element,

FIG. 3b is a schematic side view of an ejector device and a retaining element,

FIG. 4 is a schematic exploded view of an ejector device and a retaining element,

FIG. 5a-k shows section A-A of FIG. 3b in different positions of the folding door or folding sliding door,

FIG. 6a-k shows section B-B of FIG. 3b in different positions of the folding door or folding sliding door,

FIG. 7a-k shows section C-C of FIG. 3b in different positions of the folding door or folding sliding door,

FIG. 8a is an exploded view of the ejector element,

FIG. 8b is a perspective, schematic view of an ejector element, and

FIG. 8c is a perspective, schematic view of an ejector element in an overload case.

### DETAILED DESCRIPTION OF THE INVENTION

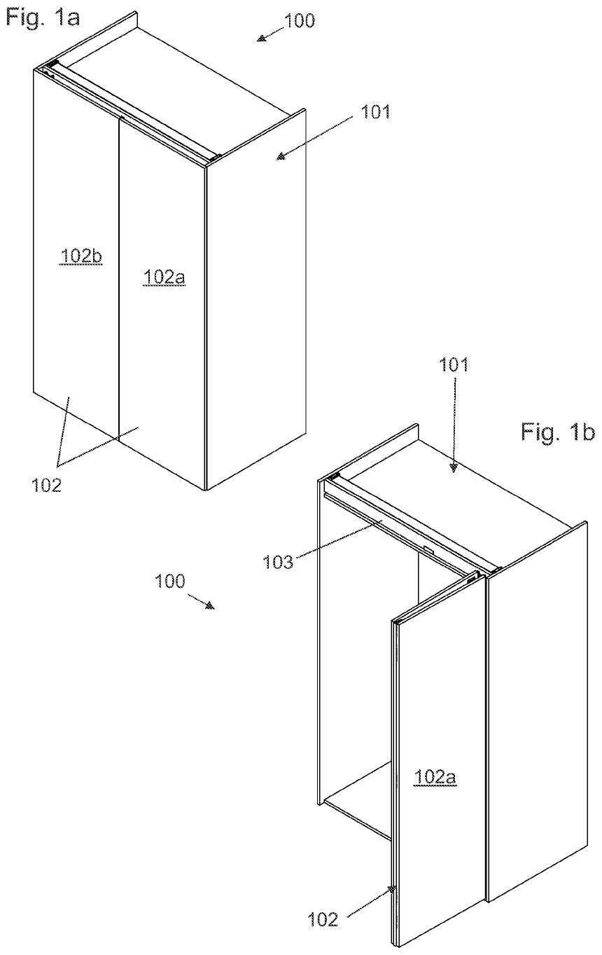

FIG. 1a shows a perspective, schematic view of a piece of furniture 100 in a closed position, and FIG. 1b shows the piece of furniture 100 in an open position. It can be seen that the piece of furniture 100 has a fixed part 101, here in the form of a furniture body. A folding-sliding door 102 is mounted on the fixed part 101.

The folding-sliding door 102 comprises two door leaves 102a, 102b connected to each other by hinges. A first door leaf 102a is hinged to the fixed furniture part 101, while a second door leaf 102b is mounted on a guide rail 103 so that it can slide.

The folding-sliding door 102 can be moved from a closed position (FIG. 1a) to an open position (FIG. 1b), making the interior of the fixed furniture part 101 accessible.

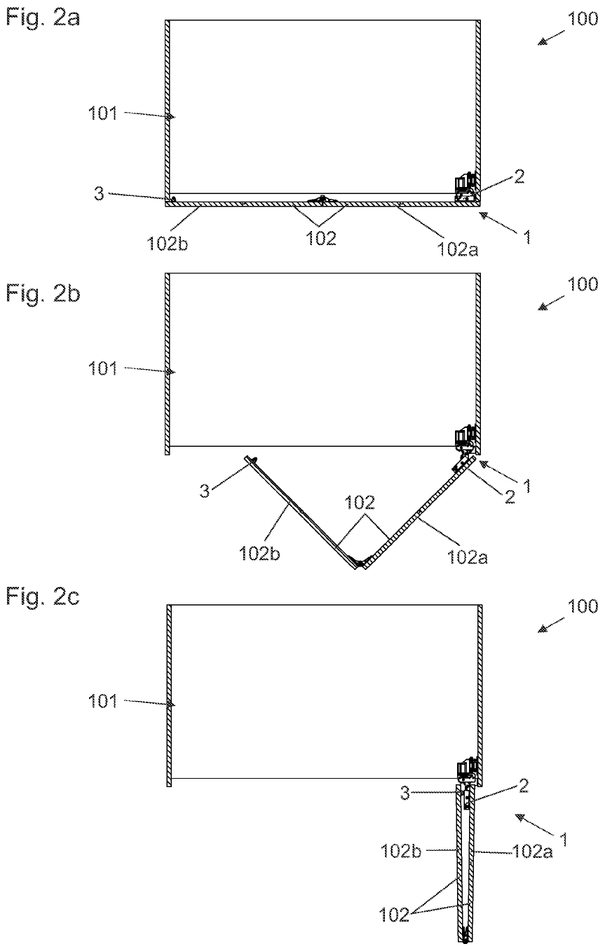

FIGS. 2a to 2c show a schematic top view of the opening process of a piece of furniture 100 and, in reverse order, the closing process.

In a closed position (FIG. 2a), the door leaves 102a, 102b lie essentially in a common closing plane. The guide rail 103 is not shown for clarity.

An ejector device 2 is arranged on the first door leaf 102a and a retaining element 3 is arranged on the second door leaf 102b. When the folding-sliding door 102 is opened, the two door leaves 102a, 102b move toward each other until they are arranged in a folded position.

The retaining element 3 engages with an ejector element 4 of the ejector device 2, thereby holding the folding-sliding door 102 in the open position. To close the folding-sliding door 102, the second door leaf 102b can be pressed toward the first door leaf 102a in the area of the retaining element 3. This releases the engagement between the retaining element 3 and the ejector element 4. In addition, the retaining element 3 is subjected to a force via the ejector element 4, so that the folding-sliding door 102 is moved at least partially into the closed position.

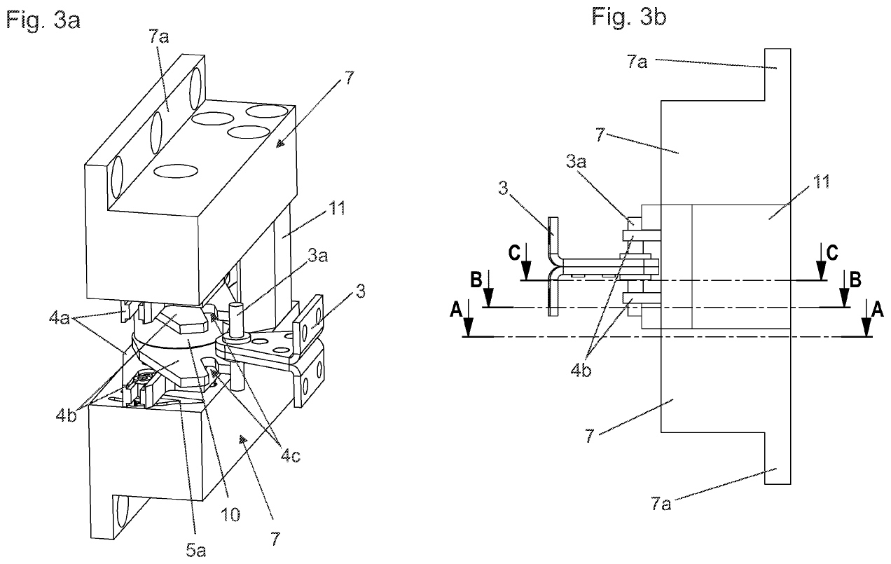

FIG. 3a shows a perspective, schematic view of an ejector device 2 and a retaining element 3, and FIG. 3b shows a schematic side view of an ejector device 2 and a retaining element 3.

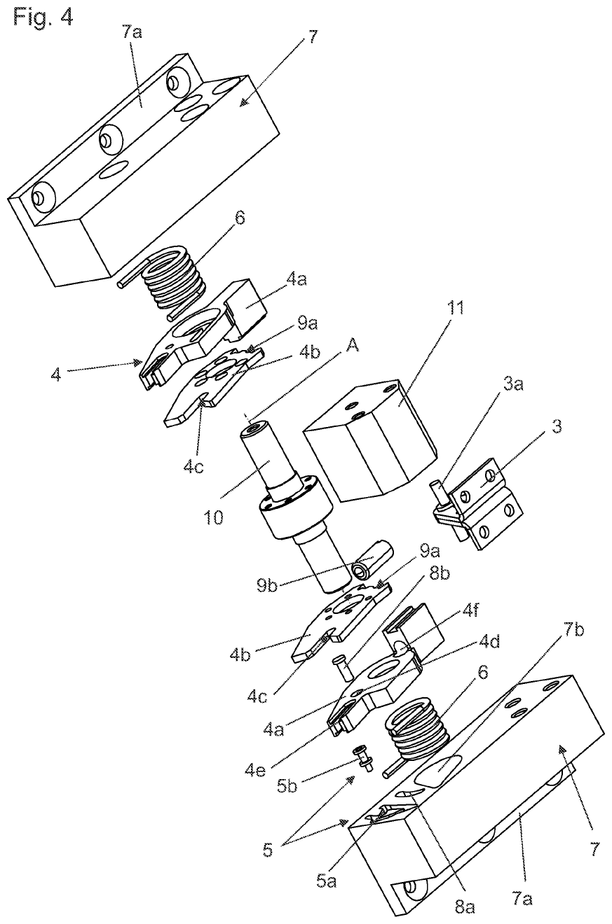

The ejector device 2 comprises two bearing devices 7, on each of which an ejector element 4 is pivotably mounted. It can also be seen that the ejector elements 4 are designed in two parts. The engagement elements 4b each have an engagement opening 4c into which a locking bolt 3a of the retaining element can engage. FIG. 4 shows the individual elements of the ejector device in more detail.

FIG. 4 shows a schematic exploded view of an ejector device 2 and a retaining element 3. As already described, the ejector elements 4 are pivotably mounted on the bearing elements 7. For this purpose, a bolt 10 is provided on which both ejector elements 4 are arranged together. The bolt 10 is mounted in recesses 7b. The bearing elements 7 also comprise fastening sections 7a, via which the bearing elements 7 can be fastened to a door leaf 102a. In this embodiment, the bearing sections 7a have openings for receiving screws. However, a variety of fastening options are conceivable in principle.

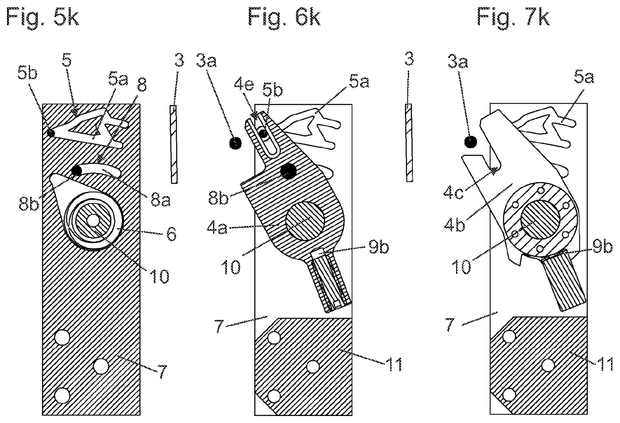

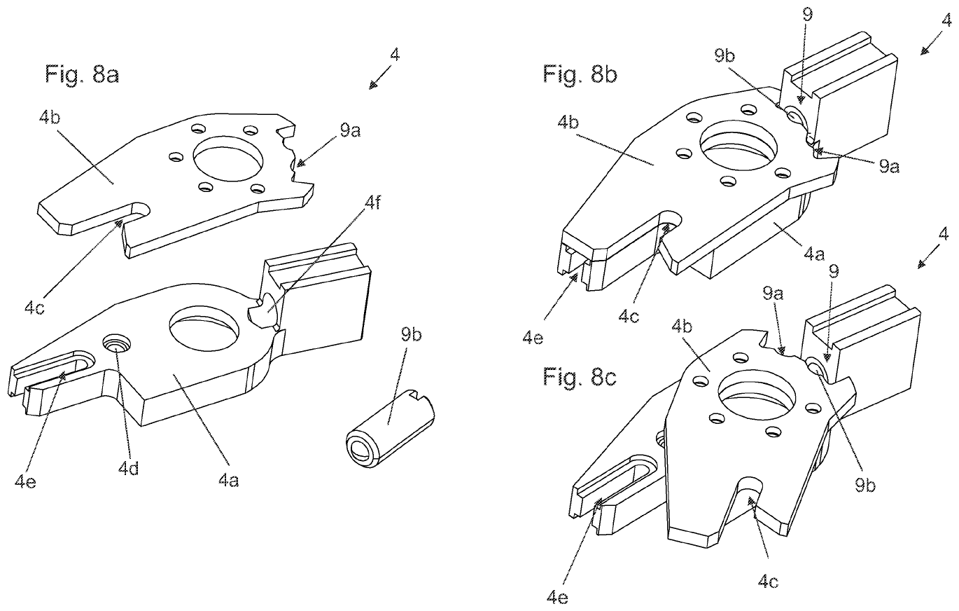

The ejector elements 4 consist of a swivel element 4a and an engagement element 4b. The swivel element 4a and the engagement element 4b are normally coupled in motion via a second force storage member 9b, which is arranged in an opening 4f in the swivel element 4a and exerts a force on a control contour 9a of the engagement element 4b. However, in the event of an overload, the engagement element 4b can be moved relative to the swivel element 4a. This is explained in more detail in FIGS. 8a to 8c. In this embodiment, the second force storage member 9b is designed as a spring-loaded ball pressure piece.

The force storage member 6 is also arranged in the recess 7b. The force storage member 6 is designed in the form of a leg spring which winds around the bolt 10. One leg of the force storage member 6 is supported in the recess 7b, while the second leg is located in a recess in the swivel element 4a. If the swivel element 4a is moved accordingly relative to the bearing element 7, the force storage member 6 can be charged.

In addition, a control cam 5a and a limiting curve 8a are visible in the bearing element 7. A limiting pin 8b is guided in the limiting curve 8a, which is mounted in a guide bore 4d in the swivel element 4a. A control pin 5b is guided in the control cam 5a. The control pin 5b is mounted so that it can be displaced in a guide groove 4e of the swivel element 4a.

A spacer 11 is provided between the bearing devices 7, which keeps the bearing devices 7 at a predetermined distance from each other.

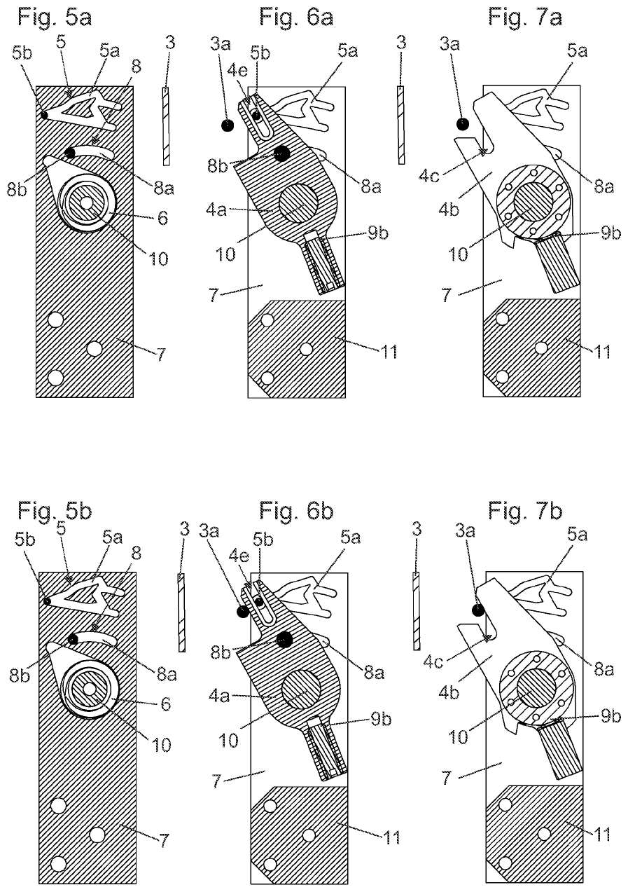

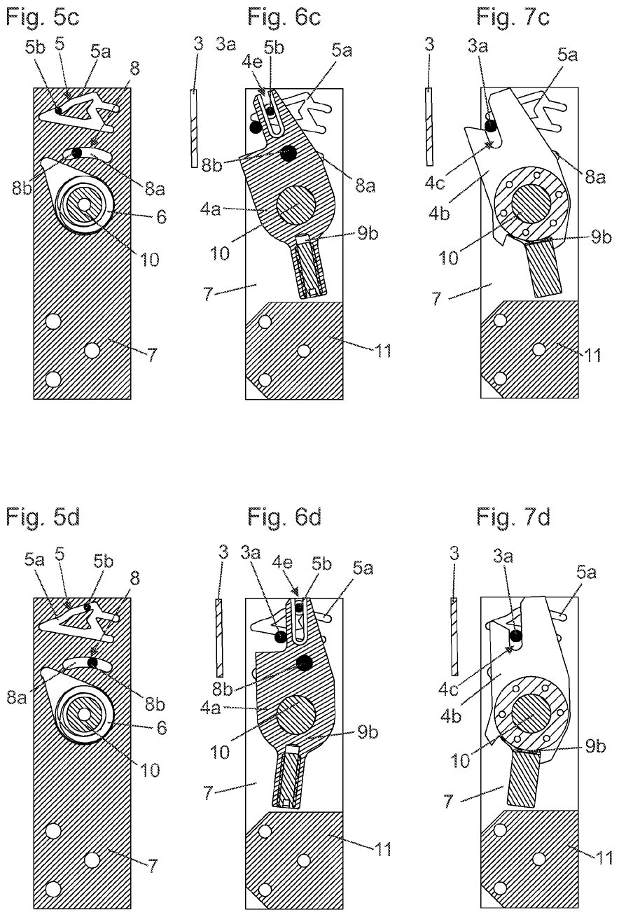

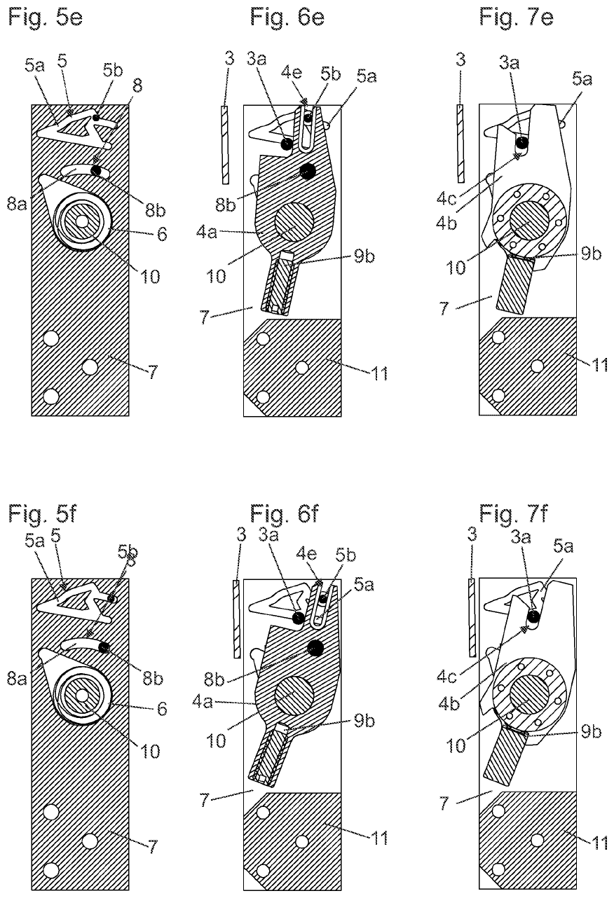

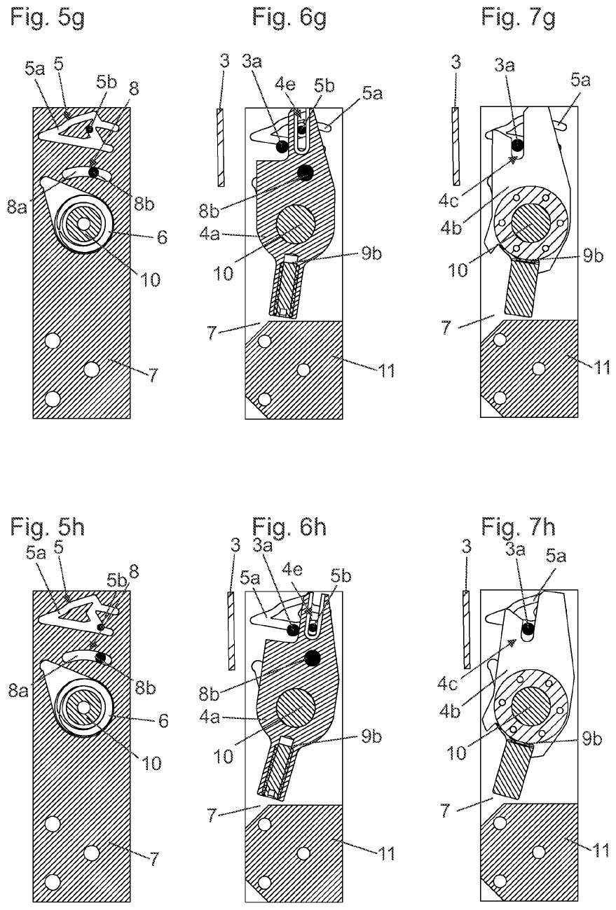

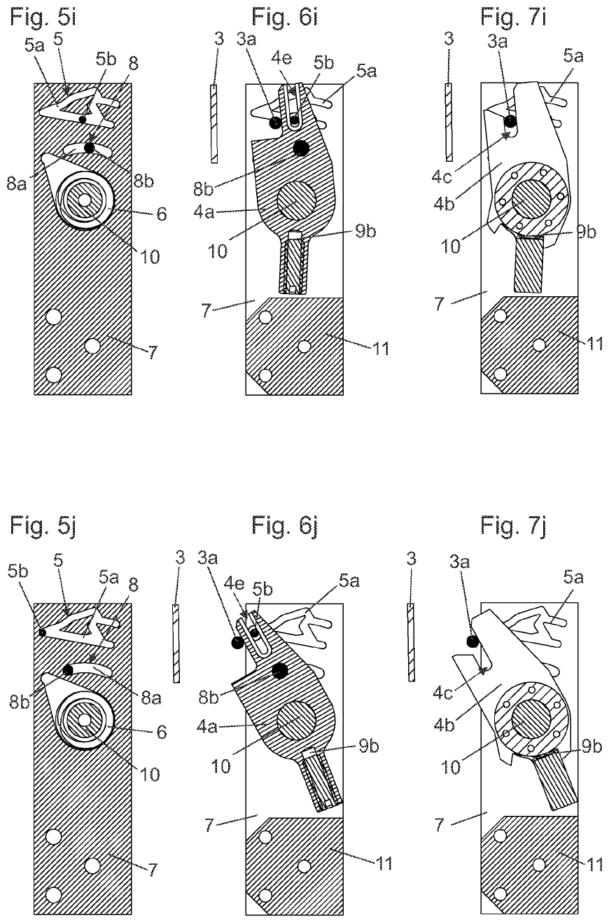

FIGS. 5a to 5k, 6a to 6k, and 7a to 7k illustrate how the ejector device 2 functions during an opening or closing operation of the folding-sliding door 102. FIGS. 5a to 5k each show section A-A according to FIG. 3b in the corresponding step, FIGS. 6a to 6k each show section B-B, and FIGS. 7a to 7k each show section C-C. The same letter abbreviations refer to the same step.

FIGS. 5a, 6a, and 7a show that the folding-sliding door 102 is not yet fully open. The locking bolt 3a of the retaining element 3 is not in contact with the ejector device 2. The ejector element 4 is pressed toward the retaining element 3 by the force storage member 6. The limit bolt 8a is located at the leftmost end of the limit curve 8b and thus prevents further movement of the ejector element 4 toward the retaining element 3.

In the next step (FIGS. 5b, 6b, 7b), the locking bolt 3a contacts the swivel element 4. This causes swivel element 4 to swivel against the force of the force storage member 6. The control pin 5b and the limit pin 8b move in their respective guide curves 5a, 8a (FIG. 5c, 6c, 7c). The control cam 5a is designed as a heart curve.

Subsequently, the ejector element 4 is further pivoted, causing the locking bolt 3a to engage with the engagement opening 4c of the engagement element 4b (FIGS. 5d, 6d, 7d).

The ejector element 4 is further pivoted toward the first door leaf 102a, causing the control pin 5a to pass over the upper elevation in the control cam 5b (FIGS. 5e, 6e, 7e).

Finally, the ejector element 4 reaches a second end position in which the limiting bolt 8b and the limiting curve 8a prevent further movement of the ejector element 4 (FIGS. 5f, 6f, 7f). The limiting bolt 8b and the limiting curve 8a thus form a limiting device 8.

As soon as a user stops pressing on the door leaf 102b and thus on the retaining element 3, the ejector element 4 is pressed back toward the second door leaf 102b by the force storage member 6 until the control pin 5b engages in the locking point of the control cam 5a (FIGS. 5g, 6g, 7g). The folding-sliding door 102 is in the open position. The locking bolt 3a, which engages in the engagement opening 4c, holds the folding-sliding door 102 in the open position by means of the ejector device 2 and the retaining element 3. The control cam 5a and the control bolt 5b thus form a locking device 5 by means of which the engagement between the locking bolt 3a and the ejector element 4 can be locked.

To close the folding-sliding door 102, the second door leaf 102b, and thus the retaining element 3, is pressed toward the first door leaf 102a. This causes the ejector element 4 to pivot back. The control pin 5b is moved out of its locking position and guided downwards along the control cam 5a (FIGS. 5h, 6h, 7h). The folding-sliding door 102 is therefore compressed beyond an open position when unlocked by pressure being exerted on the second door leaf 102b. This also additionally charges the force storage member 6.

The force storage member 6 moves the ejector element 4 in the direction of the second door leaf 102b (FIG. 5i, 6i, 7i) until the locking bolt 4a is released by the ejector element 4 (FIG. 5j, 6j, 7j) and ejected by the force stored in the force storage member 6 (FIG. 5k, 6k, 7k). The ejector element 4 is prevented from further movement by the limiting bolt 8b and the limiting curve Ba. The force applied to the ejector element 4 moves the retaining element 3 and thus the second door leaf 102b, causing the folding-sliding door 102 to be moved at least partially into a closed position.

FIG. 8a shows an exploded view of ejector element 4, FIG. 8b shows a perspective, schematic view of an ejector element 4, and FIG. 8c shows a perspective, schematic view of an ejector element 4 in an overload situation.

It can again be seen that the swivel element 4a has a control contour 9a. A second force storage member 9b in the form of a spring-loaded ball pressure piece is arranged in an opening 4f in the swivel element 4a and exerts a force on the control contour 9a. The ball of the ball pressure piece is thus pressed against the control contour 9a, thereby establishing a movement coupling between the swivel element 4a and the engagement element 4b.

In the event of an overload, for example if a user pulls on the second door leaf 102b while the folding-sliding door 102 is locked in the open position, the second force storage member 9b is compressed via the control contour 9a. The engagement element 4b is thus pivoted relative to the swivel element 4a, which is locked by the control pins 5b and the control cam 5a, thereby releasing the locking pin 3a. The control contour 9a and the force storage member 9b thus form an overload protection device 9.

This prevents the ejector device 2 from being damaged in the event of an overload.

### REFERENCE LIST

1 Arrangement
2 Ejector device
3 Retaining element
3a Locking bolt
4 Ejector element
4a Swivel element
4b Engagement element
4c Engagement opening
4d Guide bore
4e Guide groove
4f Opening
5 Locking device
5a Control cam
5b Control pin
6 Force storage member
7 Bearing element
7a Fastening section
7b Recess
8 Limiting device
8a Limiting curve
8b Limiting pin
9 Overload protection
9a Control contour
9b Second force storage member
10 Bolt
11 Spacer
100 Furniture
101 Furniture body
102 Folding door or folding-sliding door
102a First door leaf
102b Second door leaf
103 Guide rail
A Axis

1. An arrangement comprising:
at least one folding door or folding-sliding door, which comprises at least two door leaves connected to each other in an articulated manner, wherein the at least two door leaves are arranged in a common closing plane,
at least one ejector device arranged on a first of the two door leaves for transferring the at least one folding door or folding-sliding door from a folded open position at least partially into a closed position, wherein the ejector device has at least one ejector element, and
at least one holding element arranged on a second one of the two door leaves,
wherein the at least one ejector element can be brought into engagement with the holding element to hold the at least one folding door or folding-sliding door in the open position, and
wherein the at least one ejector element is configured to apply a force to the holding element to move the second door leaf from the open position into the closed position.

2. The arrangement according to claim 1, wherein the at least one ejector element has an engagement opening, wherein a locking bolt of the holding element can be brought into engagement with the engagement opening.

3. The arrangement according to claim 1, wherein the at least one ejector device has at least one locking device for releasably locking the holding element to the at least one ejector element.

4. The arrangement according to claim 3, wherein the at least one locking device can be unlocked when the ejector device is mounted by exerting pressure on the folding door or folding-sliding door, preferably in the area in which the holding element is arranged.

5. The arrangement according to claim 4, wherein the folding door or folding-sliding door is compressed beyond an open position when unlocked by the application of pressure.

6. The arrangement according to claim 3, wherein the locking device comprises at least one control cam, preferably a heart-shaped control cam, wherein at least one control pin is provided, which is arranged or formed on the at least one ejector element and is guided in the control cam.

7. The arrangement according to claim 1, wherein the ejector element can be actuated by means of at least one force storage member to be charged manually by a user, preferably wherein the force storage member comprises at least one leaf spring.

8. The arrangement according to claim 3, wherein the at least one ejector element can be locked by the locking device against the action of the at least one charged force storage member.

9. The arrangement according to claim 1, wherein the ejector device comprises at least one, preferably two, bearing elements.

10. The arrangement according to claim 9, wherein the at least one ejector element is pivotably mounted on the at least one bearing element.

11. The arrangement according to claim 9, wherein the bearing element has at least one fastening section for fastening the at least one bearing element to a door leaf.

12. The arrangement according to claim 6, wherein the control cam is formed on the at least one bearing element.

13. The arrangement according to claim 1, wherein the ejector device has at least one limiting device for limiting a rotational movement of the at least one ejector element.

14. The arrangement according to claim 13, wherein the limiting device comprises at least one limiting curve, wherein a limiting bolt arranged or formed on the at least one ejector element is guided in the limiting curve.

15. The arrangement according to claim 9, wherein the limiting curve is formed on the at least one bearing element.

16. The arrangement according to claim 7, wherein the at least one force storage member acts between the at least one bearing element and the at least one ejector element.

17. The arrangement according to claim 1, wherein at least two ejector elements are provided, wherein the at least two ejector elements are mounted so as to be pivotable on a common axis.

18. The arrangement according to claim 1, wherein the at least one ejector element comprises a pivoting element and an engagement element.

19. The arrangement according to claim 6, wherein the control pin and/or the limiting pin are arranged or formed on the pivoting element, and/or the pivoting element has a receptacle for at least partially receiving the force storage member.

20. The arrangement according to claim 2, wherein the engagement element has the engagement opening.

21. The arrangement according to claim 1, wherein the ejector device has at least one overload protection device.

22. The arrangement according to claim 18, wherein the pivoting element and the engagement element are part of the overload protection device, wherein the engagement element has a control contour which can be acted upon by a force storage member.

23. The arrangement according to claim 22, wherein the engagement element can be pivoted relative to the pivoting element against the force exerted by the second force storage member when a predetermined force is reached.

24. The arrangement according to claim 23, wherein the second force storage member is mounted on or in the pivoting element.

25. A furniture comprising at least one fixed furniture part, preferably a furniture body, and the arrangement according to claim 1, wherein the at least one folding door or folding-sliding door is mounted on the at least one fixed furniture part.
